(19) United States
(12) Patent Application Publication
(10) Pub. No.: US 2025/0304101 A1
(43) Pub. Date: Oct. 2, 2025

(54) Vehicle Control Device and Vehicle Control Method

(71) Applicants: Hyundai Motor Company, Seoul (KR); Kia Corporation, Seoul (KR)

(72) Inventors: Jin Sol Kim, Hwaseong-Si (KR); Woong Hyun Ka, Hwaseong-si (KR); Jang Yoon Kim, Hwaseong-Si (KR); Jin Woo Bae, Hwaseong-Si (KR)

(21) Appl. No.: 18/963,398

(22) Filed: Nov. 27, 2024

(30) Foreign Application Priority Data
Apr. 2, 2024 (KR) 10-2024-0044832

(51) Int. Cl. B60W 60/00; B60W 50/00; G01S 17/89; G06T 7/50; G06T 7/80; G06V 10/82; G06V 20/56

(52) U.S. Cl. CPC B60W 60/001; B60W 50/00; G01S 17/89; G06T 7/50; G06T 7/80; G06V 10/82; G06V 20/56; B60W 2050/0083; B60W 2420/403; B60W 2420/408; G06T 2207/10028; G06T 2207/20084; G06T 2207/30252

(57) ABSTRACT

An apparatus for controlling autonomous driving of a vehicle comprises a first sensor, a second sensor, a memory configured to store a neural network model, and a processor. The processor obtains coordinates of an object from an image acquired by the first sensor, based on intrinsic and extrinsic parameters or a distortion coefficient of the first sensor. It then inputs the image or coordinates into the neural network model to generate a first depth map. A second depth map is obtained based on a cluster of points acquired by the second sensor. By comparing the first and second depth maps, the processor determines any difference between them, outputs a signal indicating this difference, and controls the vehicle's autonomous driving based on the signal.

### CROSS-REFERENCE TO RELATED APPLICATION

This application claims the benefit of priority to Korean Patent Application No. 10-2024-0044832, filed in the Korean Intellectual Property Office on Apr. 2, 2024, the entire contents of which are incorporated herein by reference.

### TECHNICAL FIELD

The present disclosure relates to a vehicle control device and a vehicle control method, and more particularly, to a technique using a neural network model.

### BACKGROUND

The matters described in this Background section are only for enhancement of understanding of the background of the disclosure, and should not be taken as acknowledgement that they correspond to prior art already known to those skilled in the art.

As research on autonomous driving technologies for vehicles and/or driving assistance technologies for vehicles are being progressed, research on technology for identifying or determining external objects using sensors included in a vehicle (e.g., camera, LIDAR, and/or radar) is actively underway.

In particular, the distance between an external object and a vehicle may be accurately measured using a camera. In the case of a camera view that does not exist in the learning database (DB) of a neural network model used when measuring a distance between an external object and a vehicle using a camera, a very large error may occur.

Therefore, there is a need to accurately measure the distance between an external object and a vehicle using a neural network model in various environments (e.g., a camera view that do not exist in the learning database).

### SUMMARY

According to the present disclosure, an apparatus for controlling autonomous driving of a vehicle, the apparatus may comprise a first sensor, a second sensor, a memory configured to store a neural network model, and a processor configured to: obtain coordinates of an object from an image may comprise the object, wherein the image is acquired by the first sensor based on at least one of an intrinsic parameter of the first sensor, an extrinsic parameter of the first sensor, or a distortion coefficient of the first sensor, obtain a first depth map by inputting at least one of the image or the coordinates into the neural network model, obtain, based on a cluster of points acquired by the second sensor, a second depth map, determine, based on comparing the first depth map and the second depth map, a difference between the first depth map and the second depth map, output a signal indicating the difference, and control, based on the signal, autonomous driving of the vehicle.

The processor is configured to determine, based on feature modeling for the first sensor, the intrinsic parameter and the distortion coefficient, and determine, based on a position of the first sensor on the vehicle, the extrinsic parameter.

The processor is configured to, based on an angle between a first reference line facing a front of the vehicle and a second reference line formed with respect to an optical axis of the first sensor exceeding a first reference angle, perform automatic online calibration to realign the second reference line with respect to the first reference line, wherein the vehicle may comprise the first sensor.

The processor is configured to obtain a second vehicle coordinate system based on rotating a first vehicle coordinate system by a second reference angle, wherein the first vehicle coordinate system is formed with respect to a center point of a front bumper of the vehicle, and wherein the vehicle may comprise the first sensor, obtain, based on shifting the second vehicle coordinate system by a reference distance, a third vehicle coordinate system corresponding to a first sensor coordinate system, wherein the first sensor coordinate system is formed with respect to the first sensor, and obtain the coordinates, wherein the third vehicle coordinate system may comprise the extrinsic parameter.

The processor is configured to obtain a first matrix by applying a specified equation to the third vehicle coordinate system, wherein the specified equation may comprise the distortion coefficient, and obtain, based on the first matrix, the coordinates.

The processor is configured to obtain, based on at least one of a focal length of the first sensor, a skew coefficient of the first sensor, or a principal point of the image, a second matrix, obtain, based on the first matrix and the second matrix, the coordinates, and obtain the first depth map by inputting the coordinates into the neural network model.

The processor is configured to obtain, based on a plurality of planes separated with respect to a reference axis of the vehicle, the coordinates, wherein the vehicle may comprise the first sensor, and wherein the reference axis may comprise an axis perpendicular to a ground with respect to a specified position of the vehicle.

The neural network model may comprise an encoder into which the image is inputted and a decoder into which the coordinates are inputted, and wherein the neural network model is configured to obtain image features for input to the decoder by inputting the image to the encoder, and output, based on the image features and the coordinates, the first depth map.

The processor is configured to train, based on the first depth map and the second depth map, the neural network model to reduce a size of the difference.

The processor is configured to apply a first weight to the image, apply a second weight to the coordinates, and train, based on the image and the coordinates, the neural network model, wherein the first weight has been applied to the image, and wherein the second weight has been applied to the coordinates.

According to the present disclosure, a method performed by an apparatus, for controlling autonomous driving of a vehicle, the method may comprise obtaining coordinates of an object from an image may comprise the object, wherein the image is acquired by a first sensor based on at least one of an intrinsic parameter of the first sensor, an extrinsic parameter of the first sensor, or a distortion coefficient of the first sensor, obtaining a first depth map by inputting at least one of the image or the coordinates into a neural network model, obtaining, based on a cluster of points acquired by a second sensor, a second depth map, and determining, based on comparing the first depth map and the second depth map, a difference between the first depth map and the second depth map, outputting a signal indicating the difference, and controlling, based on the signal, autonomous driving of the vehicle.

The method may further comprise determining, based on feature modeling for the first sensor, the intrinsic parameter and the distortion coefficient, and determining, based on a position of the first sensor on the vehicle, the extrinsic parameter.

The method may further comprise, based on an angle between a first reference line facing a front of the vehicle and a second reference line formed with respect to an optical axis of the first sensor exceeding a first reference angle, performing automatic online calibration to realign the second reference line with respect to the first reference line, wherein the vehicle may comprise the first sensor.

The method may further comprise obtaining a second vehicle coordinate system based on rotating a first vehicle coordinate system by a second reference angle, wherein the first vehicle coordinate system is formed with respect to a center point of a front bumper of the vehicle, obtaining, based on shifting the second vehicle coordinate system by a reference distance, a third vehicle coordinate system corresponding to a first sensor coordinate system, wherein the first sensor coordinate system is formed with respect to the first sensor, and obtaining the coordinates, wherein the third vehicle coordinate system may comprise the extrinsic parameter.

The method may further comprise obtaining a first matrix by applying a specified equation to the third vehicle coordinate system, wherein the specified equation may comprise the distortion coefficient, and obtaining, based on the first matrix, the coordinates.

The method may further comprise obtaining, based on at least one of a focal length of the first sensor, a skew coefficient of the first sensor, or a principal point of the image, a second matrix, obtaining, based on the first matrix and the second matrix, the coordinates, and obtaining the first depth map by inputting the coordinates into the neural network model.

The method may further comprise obtaining, based on a plurality of planes separated with respect to a reference axis of the vehicle, the coordinates, wherein the vehicle may comprise the first sensor, wherein the reference axis may comprise an axis perpendicular to a ground with respect to a specified position of the vehicle.

The method, wherein the neural network model may comprise an encoder into which the image is inputted and a decoder into which the coordinates are inputted, wherein the neural network model is configured to obtain image features for input to the decoder by inputting the image to the encoder, and output, based on the image features and the coordinates, the first depth map.

The method may further comprise training, based on the first depth map and the second depth map, the neural network model to reduce a size of the difference.

The method may further comprise applying a first weight to the image, applying a second weight to the coordinates, and training, based on the image and the coordinates, the neural network model, wherein the first weight has been applied to the image, and wherein the second weight has been applied to the coordinates.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram relating to a vehicle control device according to an example of the present disclosure;

FIG. 2 shows an example of outputting a loss function according to an example of the present disclosure;

FIG. 3 shows an example of performing division into a plurality of planes with reference to a reference axis of a vehicle, according to an example of the present disclosure;

FIG. 4 shows an example related to camera distortion according to an example of the present disclosure;

FIG. 5 shows an example of a flowchart related to a vehicle control method according to an example of the present disclosure; and

FIG. 6 shows an example of a computing system related to a vehicle control device or a vehicle control method according to an example of the present disclosure.

### DETAILED DESCRIPTION

Hereinafter, some examples of the present disclosure will be described in detail with reference to the exemplary drawings. In adding the reference numerals to the components of each drawing, it should be noted that the identical or equivalent component is designated by the identical numeral even when they are displayed on other drawings. Further, in describing the example of the present disclosure, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

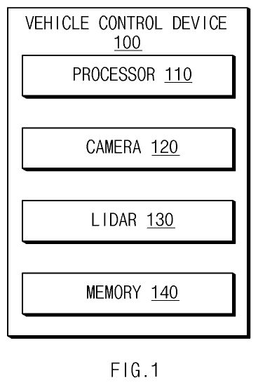

Hereinafter, examples of the present disclosure will be described in detail with reference to FIGS. 1 to 6.

FIG. 1 shows an example of a block diagram relating to a vehicle control device according to an example of the present disclosure.

Referring to FIG. 1, a vehicle control device 100 according to an example of the present disclosure may be implemented inside or outside a vehicle, and part of components included in the vehicle control device 100 may be implemented inside or outside the vehicle. In this case, the vehicle control device 100 may be integrally formed with internal control units of the vehicle, or may be implemented as a separate device and connected to the control units of the vehicle by separate connection means. For example, the vehicle control device 100 may further include components not shown in FIG. 1.

The vehicle control device 100, according to an example, may include a processor 110, a camera 120, a LIDAR 130, and a memory 140. The processor 110, the camera 120, the LIDAR 130, or the memory 140 may be electronically and/or operably coupled with each other by an electronical component including a communication bus.

Hereinafter, the operably coupling of hardware may refer, for example, to a direct or indirect connection between hardware being established by wire or wirelessly, such that a second hardware is controlled by a first hardware among the hardware.

The examples shown in the different blocks are not intended to be limiting. A part of the pieces of hardware of FIG. 1 may be included in a single integrated circuit, including a system on a chip (SoC). The types and/or number of pieces of hardware included within the vehicle control device 100 are not limited to those shown in FIG. 1. For example, the vehicle control device 100 may include only a part of the hardware shown in FIG. 1.

The vehicle control device 100 according to an example may include hardware for processing data based on one or more instructions. The hardware for processing the data may include the processor 110.

For example, the hardware for processing data may include an arithmetic and logic unit (ALU), a floating point unit (FPU), a field programmable gate array (FPGA), a central processing unit (CPU), and/or an application processor (AP). The processor 110 may have the structure of a single-core processor, or the structure of a multi-core processor including dual core, quad core, Hexa core, or octa core.

The camera 120 of the vehicle control device 100, according to an example, may include one or more light sensors (e.g., charged coupled device (CCD) sensors, complementary metal oxide semiconductor (CMOS) sensors) that generate electrical signals indicative of the color and/or brightness of light. A plurality of light sensors included in the camera 120 may be arranged in the form of a two-dimensional array. The camera 120 may acquire electrical signals from the plurality of light sensors substantially simultaneously, and generate images and/or frames including a plurality of pixels corresponding to light reaching the light sensors in the two-dimensional grid and arranged in two dimension.

For example, photographic data captured using the camera 120 may refer to a plurality of images acquired from a plurality of cameras including the camera 120. For example, video data captured using the plurality of cameras may be a sequence of a plurality of images acquired at a specified frame rate from the plurality of cameras.

The vehicle control device 100, according to an example, may include the LIDAR 130. For example, the LIDAR 130 may acquire sets of data identifying or determining a surrounding object of the vehicle control device 100 (or a vehicle including the vehicle control device 100). For example, the LIDAR 130 may identify or determine at least one of a position, a movement direction, or a speed of the surrounding object, or any combination thereof based on the pulse laser signal emitted from the LIDAR 130 being reflected and returned to the surrounding object.

For example, the LIDAR 130 may acquire data sets representing the surrounding object (an external object) in a space formed by an x axis, a Y axis, and a z axis based on the pulse laser signal reflected from the surrounding object.

For example, the LIDAR 130 may acquire data sets that include a plurality of points in the space formed by the x axis, Y axis, and z axes based on receiving a pulse laser signal at specified intervals.

The processor 110 included in the vehicle control device 100 according to an example may enable light to be emitted from the vehicle using the LIDAR 130. For example, the processor 110 may receive light emitted from the vehicle. For example, the processor 110 may identify or determine at least one of a position, speed, or movement direction of the surrounding object, or any combination thereof based on a time of transmitting light emitted from the vehicle and a time of receiving the light emitted from the vehicle.

According to an example, the memory 140 of the vehicle control device 100 may include hardware components for storing data and/or instructions that are input to and/or output from the processor 110 of the vehicle control device 100.

For example, the memory 140 may include a volatile memory including a random-access memory (RAM), or a non-volatile memory including a read-only memory (ROM).

For example, the volatile memory may include at least one of dynamic RAM (DRAM), static RAM (SRAM), cache RAM or pseudo SRAM (PSRAM), or any combination thereof.

For example, the non-volatile memory may include at least one of programmable ROM (PROM), erasable PROM (EPROM), electrically erasable PROM (EEPROM), flash memory, hard disk, compact disc, solid state drive (SSD) or embedded multi-media card (eMMC), or any combination thereof.

For example, the memory 140 may include a neural network model. For example, the neural network model may be stored in the memory 140. The neural network model may include a deep learning-based monocular depth estimation (MDE) network model. For example, the neural network model may include an encoder, and/or a decoder. For example, the neural network model may include an encoder into which an image is input, and/or a decoder into which image coordinates are input.

For example, the neural network model may obtain image features for input to the decoder based on the image input to the encoder. For example, the neural network model may output a first depth map based on the image features and the image coordinates.

According to an example, the processor 110 of the vehicle control device 100 may acquire an image via the camera 120. The processor 110 may identify or determine at least one of an intrinsic parameter of the camera 120, an extrinsic parameter of the camera 120, or a distortion factor of the camera 120, or any combination thereof. The processor 110 may obtain image coordinates to be input to the neural network model from the image acquired by the camera 120, based on at least one of the intrinsic parameter of the camera 120, the extrinsic parameter of the camera 120, or the distortion factor of the camera 120, or any combination thereof.

For example, the intrinsic parameter of the camera 120 may be obtained based on a focal length of the camera 120, a size of an image sensor included in the camera 120, and/or a principal point of an image acquired by the camera 120.

For example, the intrinsic parameter of the camera 120 may be expressed as in Equation 1 below.

$$[ \begin{matrix}{f}_{x} & 0 & {c}_{x} \\ 0 & {f}_{y} & {c}_{y} \\ 0 & 0 & 1\end{matrix} ] \qquad [ Equation 1 ]$$

For example, in Equation 1, fₓ and/or f_{y} may be related to a focal length of the camera 120. For example, fₓ and/or f_{y} may be obtained based on a ratio of the focal length of the camera 120 and/or the size of the image sensor included in the camera 120.

For example, fₓ may be obtained based on a ratio of the focal length of the camera 120 and the size of the image sensor in the horizontal direction. For example, f_{y} may be obtained based on a ratio of the focal length of the camera 120 and the size of the image sensor in the vertical direction.

For example, as fₓ and/or f_{y} increases, the field of view (FOV) may decrease, and as fₓ and/or f_{y} decreases, the FOV may increase.

For example, in Equation 1, cₓ and/or c_{y} may be related to the principal point of the image. For example, cₓ and/or c_{y} may include values that are used to capture a particular portion of a formed entire image to generate the actual image.

For example, cₓ may include a value in the x-axis direction (i.e., horizontal direction) that is used to acquire an actual image from the entire image. c_{y} may include a value in the y-axis direction (i.e., the vertical direction) that is used to obtain the actual image from the entire image.

In an example, the processor 110 may obtain the intrinsic parameter and/or distortion coefficient of the camera 120 based on feature modeling for the camera 120.

For example, the distortion coefficient of the camera 120 may be related to Equation 2 below.

$$r ( θ , {k}_{1} , {k}_{2} , {k}_{3} , {k}_{4} , {k}_{5} ) = {k}_{1} θ + {k}_{2} {θ}^{3} + {k}_{3} {θ}^{5} + {k}_{4} {θ}^{7} + {k}_{5} {θ}^{9} \qquad [ Equation 2 ]$$

In Equation 2, k₁ to k₅ may include a value determined by camera models. In Equation 2, θ may include the angle of incidence at which light utilized to obtain pixels included in the image is incident on an image sensor.

For example, if the camera 120 is not a pinhole camera, nonlinearity may be modeled through Equation 2, which is a polynomial function.

In an example, the processor 110 may identify or determine the intrinsic parameter of the camera 120, and/or the distortion coefficient of the camera 120, based on the feature modeling for the camera 120. The processor 110 may identify or determine an extrinsic parameter based on a positional relationship between the camera 120 and a vehicle comprising the camera 120.

In an example, the processor 110 may identify or determine a first reference line facing the front of the vehicle including the camera 120. For example, the processor 110 may identify or determine a first reference line formed from a center of the front bumper of the vehicle including the camera 120 towards the front of the vehicle.

In one example, the processor 110 may identify or determine a second reference line formed with respect to an optical axis of the camera 120.

For example, the processor 110 may identify or determine an angle between the first reference line facing the front of the vehicle including the camera 120 and the second reference line formed with respect to the optical axis of the camera 120. For example, the processor 110 may perform automatic online calibration to realign the second reference line with respect to the first reference line based on the angle between the first reference line and the second reference line exceeding a first reference angle.

For example, the processor 110 may obtain the extrinsic parameter of the camera 120 relatively accurately by realigning the first reference line and the second reference line.

In an example, the processor 110 may identify or determine a first vehicle coordinate system formed with respect to a center point of the front bumper of the vehicle including the camera 120. The processor 110 may rotate the first vehicle coordinate system by a second reference angle. For example, the processor 110 may obtain a second vehicle coordinate system based on rotating the first vehicle coordinate system formed with respect to the center point of the front bumper of the vehicle including the camera 120 by the second reference angle.

In an example, the processor 110 may shift the second vehicle coordinate system by a specified distance. For example, the processor 110 may obtain a third vehicle coordinate system corresponding to a camera coordinate system formed with respect to the center of the camera 120 based on shifting the second vehicle coordinate system by a reference distance.

In an example, the processor 110 may obtain image coordinates based on the third vehicle coordinate system that includes the extrinsic parameter.

For example, by performing the operations described above, the processor 110 may obtain a matrix corresponding to Equation 3 below.

$$[ \begin{matrix}{X}_{C} \\ {Y}_{C} \\ {Z}_{C}\end{matrix} ] = [ \begin{matrix}{R}_{11}^{V \to C} & {R}_{12}^{V \to C} & {R}_{13}^{V \to C} \\ {R}_{21}^{V \to C} & {R}_{22}^{V \to C} & {R}_{23}^{V \to C} \\ {R}_{31}^{V \to C} & {R}_{32}^{V \to C} & {R}_{33}^{V \to C}\end{matrix} ] [ \begin{matrix}{X}_{V} \\ {Y}_{V} \\ {Z}_{V}\end{matrix} ] + [ \begin{matrix}{T}_{1}^{V \to C} \\ {T}_{2}^{V \to C} \\ {T}_{3}^{V \to C}\end{matrix} ] \qquad [ Equation 3 ]$$

In Equation 3, Rₖₗ^{V→C} may mean a rotation of the vehicle coordinate system. For example, in Rₖₗ^{V→C}, ‘k’ may represent rows and ‘l’ may represent columns. In Equation 3, Tₘ^{V→C} may mean shifting the vehicle coordinate system. In, ‘m’ may denote a row.

In an example, the processor 110 may apply a specified equation, including a distortion coefficient, to the third vehicle coordinate system. For example, the processor 110 may obtain a first matrix based on applying the specified equation including a distortion coefficient to the third vehicle coordinate system.

For example, the specified equation may include Equation 4 below.

$$[ \begin{matrix}{x}_{d . n .} \\ {y}_{d . n .}\end{matrix} ] = \frac{r ( θ , {k}_{1} , {k}_{2} , {k}_{3} , {k}_{4} , {k}_{5} )}{{r}_{u . n .}} [ \begin{matrix}{x}_{u . n .} \\ {y}_{u . n .}\end{matrix} ] \qquad [ Equation 4 ]$$

In Equation 4,

$$[ \begin{matrix}{x}_{u . n .} \\ {y}_{u . n .}\end{matrix} ]$$

may be obtained based on a plurality of planes separated with respect to the reference axis of the vehicle including the camera 120. u.n. may be an abbreviation for undistorted normalization. d.n. may be an abbreviation for distorted normalization. For example,

$$[ \begin{matrix}{x}_{d . n .} \\ {y}_{d . n .}\end{matrix} ]$$

in Equation 4 may be the first matrix described above. For example, r_{u.n.} may correspond to

$$\sqrt{{x}_{u . n .}^{2} + {y}_{u . n .}^{2}}$$

For example,

$$[ \begin{matrix}{x}_{u . n .} \\ {y}_{u . n .}\end{matrix} ]$$

may be obtained based on Equation 5 below.

$$[ \begin{matrix}\begin{matrix}{x}_{u . n .} \\ {y}_{u . n .}\end{matrix} \\ 1\end{matrix} ] = \frac{1}{{Z}_{c}} [ \begin{matrix}{X}_{c} \\ {Y}_{c} \\ {Z}_{c}\end{matrix} ] \qquad [ Equation 5 ]$$

In Equation 5, Z, may include the value of the z-axis of the plurality of planes separated with respect to the reference axis of the vehicle including the camera 120. In Equation 5,

$$[ \begin{matrix}{X}_{c} \\ {Y}_{c} \\ {Z}_{c}\end{matrix} ]$$

may be obtained based on Equation 3. For example, the reference axis of the vehicle may include an axis perpendicular to the ground, with respect to a specified position of the vehicle. For example, the specified position of the vehicle may include the center point of the front bumper of the vehicle.

According to an example, the processor 110 may obtain a second matrix for input to the neural network model, based on at least one of the focal length of the camera 120, the skew coefficient of the camera 120, or the principal point of the image, or any combination thereof. For example, the second matrix may be obtained based on Equation 6 below.

$$[ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{x}_{d . n .} \\ {y}_{d . n .} \\ 1\end{matrix} ] \qquad [ Equation 6 ]$$

In Equation 6,

$$[ \begin{matrix}{x}_{d . n .} \\ {y}_{d . n .} \\ 1\end{matrix} ]$$

may be obtained based on Equation 4. In Equation 6,

$$[ \begin{matrix}{f}_{x} & 0 & {c}_{x} \\ 0 & {f}_{y} & {c}_{y} \\ 0 & 0 & 1\end{matrix} ]$$

may be obtained based on at least one of the focal length of the camera 120, the skew coefficient of the camera 120, or the principal point of an image, or any combination thereof. 0 of the first row and second column in

$$[ \begin{matrix}{f}_{x} & 0 & {c}_{x} \\ 0 & {f}_{y} & {c}_{y} \\ 0 & 0 & 1\end{matrix} ]$$

may be a value corresponding to the skew coefficient of the camera 120.

In an example, the processor 110 may obtain a first depth map based on inputting at least one of an image, or image coordinates, or any combination thereof into a neural network model.

For example, the processor 110 may obtain a first depth map based on the image and/or image coordinates input to the neural network model.

In an example, the processor 110 may obtain a second depth map based on a cluster of points (e.g., a point cloud) acquired by the LIDAR 130. For example, the processor 110 may obtain the point cloud based on grouping a plurality of points acquired by the LIDAR 130.

For example, the processor 110 may identify or determine that some of the plurality of points obtained via the LIDAR 130 correspond to an external object. The processor 110 may obtain some of the plurality of points corresponding to the external object as the point cloud, based on some of the plurality of points corresponding to the external object.

According to an example, the processor 110 may compare the first depth map with the second depth map. For example, the processor 110 may output a loss function representing a difference between the first depth map and the second depth map based on comparing the first depth map with the second depth map.

In machine learning, a loss function (e.g., a cost function or error function) is a method of evaluating how well a specific algorithm models the given data. By comparing the predicted values generated by the model to the actual target values, the loss function quantifies the error or difference. The purpose of the loss function is to guide the training process. When the model makes a prediction, the loss function computes a numerical value representing how far the prediction is from the true value. The goal of the learning algorithm is to minimize this loss value by adjusting the model's parameters during the training phase.

In an example, the processor 110 may train a neural network model. For example, processor 110 may train a neural network model to reduce the loss function. For example, the processor 110 may train a neural network model based on the first depth map and the second depth map to reduce the magnitude of a result value of the loss function.

As described above, the vehicle control device 100 according to an example may train a neural network model by using at least one of an image, or image coordinates, or any combination thereof to reduce the difference between the first depth map and the second depth map. By reducing the difference between the first depth map and the second depth map, the vehicle control device 100 may provide the effect of identifying or determining an accurate distance between an external object and a vehicle in three dimensions using only a two-dimensional image.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., a loss function, a difference between the first depth map and the second depth map, etc.) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., a loss function, a difference between the first depth map and the second depth map, etc.) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., a loss function, a difference between the first depth map and the second depth map, etc.) described herein.

Minimum risk maneuver (MRM) operation(s) may also be controlled, for example, based on one or more features (e.g., a loss function, a difference between the first depth map and the second depth map, etc.) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., a loss function, a difference between the first depth map and the second depth map, etc.) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., a loss function, a difference between the first depth map and the second depth map, etc.) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

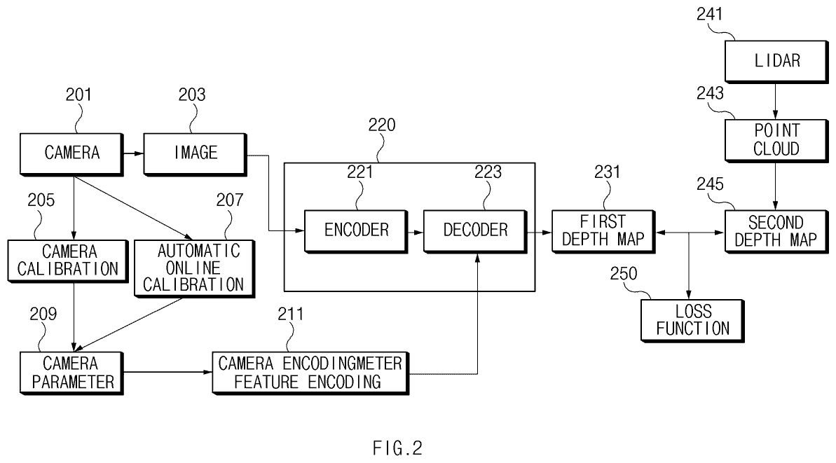

FIG. 2 shows an example of outputting a loss function according to an example of the present disclosure.

Referring to FIG. 2, a processor (e.g., the processor 110 of FIG. 1) of a vehicle control device (e.g., the vehicle control device 100 of FIG. 1) according to an example may obtain an image 203 via a camera 201 (e.g., the camera 120 of FIG. 1).

For example, the processor may perform camera calibration 205 and/or automatic online calibration 207. For example, the processor may perform the camera calibration 205 and/or the automatic online calibration 207 on the camera 201.

For example, the processor may obtain camera parameters 209 based on performing the camera calibration 205 and/or the automatic online calibration 207. For example, the camera parameters 209 may include an intrinsic parameter of the camera 201 and/or an extrinsic parameter of the camera 201. The intrinsic parameter of the camera 201 may define the characteristics of the camera's internal geometry and optics, which are independent of its position or orientation in the world. The intrinsic parameter is used for accurately mapping points in the 3D scene to their corresponding points in a 2D image. For example, the intrinsic parameter of the camera 201 may be related to any one of the focal length of the camera 201, the skew coefficient of the camera 201, or the principal point of the image 203 obtained via the camera 201, or any combination thereof. The focal length is the distance between camera lens and an image sensor, and it affects the field of view of the camera 201. The focal length may be expressed in pixel units, separately for the x and y directions because some cameras may have non-square pixels. The skew coefficient models any misalignment between the x and y axes of a camera sensor, meaning if the pixels are not exactly rectangular. The principal point is the point where the optical axis intersects the image plane. This point may be at the center of the image, but due to imperfections in the camera, it may be offset.

The extrinsic parameter of the camera 201 may define the position and orientation of the camera in the 3D world. It relates the camera's coordinate system to the world coordinate system and is used for understanding the camera's viewpoint in the scene. The extrinsic parameter may be represented by a rotation matrix and a translation vector. For example, the extrinsic parameter of camera 201 may be related to a distortion coefficient of the camera 201. In camera calibration, distortion coefficients may account for the imperfections in lenses that cause distortion in the captured image. Types of distortion may comprise radial and tangential distortions, which may be modeled using a set of coefficients.

In an example, the processor may encode (211) the features of the camera parameters based on obtaining the camera parameters 209. For example, the processor may encode (211) the features of the camera parameters to obtain image coordinates for input to a decoder 223 of a neural network model 220 based on obtaining the camera parameters 209. For example, the processor may obtain the image coordinates based on performing encoding 211 on the camera parameters 209. For example, the image coordinates may include the result value of Equation 6 described with reference to FIG. 1.

In an example, the processor may obtain the image 203 via the camera 201. The processor may input the image 203 obtained via the camera 201 to an encoder 221 included in the neural network model 220.

In an example, the processor may obtain a first depth map 231 output from the neural network model 220 based on inputting the image 203 and the encoded camera parameters 209 to the neural network model 220. A depth map is an image or matrix where each pixel represents the distance between the camera and the corresponding point in the scene. Instead of providing color or brightness information (as in regular images), a depth map may encode depth information, effectively describing the 3D structure of the scene from the camera's viewpoint.

In an example, the processor may obtain a plurality of points via a LIDAR 241 (e.g., the LIDAR 130 of FIG. 1). The processor may group at least some of the plurality of points obtained via the LIDAR 241. The processor may obtain a point cloud 243 based on grouping at least some of the plurality of points obtained via the LIDAR 241.

In an example, the processor may obtain a second depth map 245 based on obtaining the point cloud 243. For example, the processor may obtain the second depth map 245 that expresses a distance to an external object, by using the point cloud 243.

For example, the first depth map 231 may include a depth map that estimates the distance to the external object based on the image 203 obtained via the camera 201. For example, the second depth map 245 may include a depth map that indicates the distance to the external object based on the point cloud 243 obtained via the LIDAR 241. Accordingly, if the processor compares the first depth map 231 with the second depth map 245, a difference may occur between the first depth map 231 and the second depth map 245. The difference between the first depth map 231 and the second depth map 245 may be expressed by a loss function 250.

As described above, the processor may obtain the loss function 250 based on comparing the first depth map 231 with the second depth map 245. The loss function 250 may be a function expressing the difference between the first depth map 231 and the second depth map 245. The loss function 250 may mean that as the magnitude thereof decreases, the difference between the first depth map 231 and the second depth map 245 decreases, and that as the magnitude thereof increases, the difference between the first depth map 231 and the second depth map 245 increases.

In an example, the processor may train the neural network model 220 by using the first depth map 231 and the second depth map 245. For example, the processor may train the neural network model 220 based on the first depth map 231 and the second depth map 245 to reduce the size of the loss function 250.

For example, the processor may apply a first weight to the image 203. For example, the processor may apply a second weight to the image coordinates. The processor may train the neural network model 220 based on the image to which the first weight has been applied and the image coordinates to which the second weight has been applied.

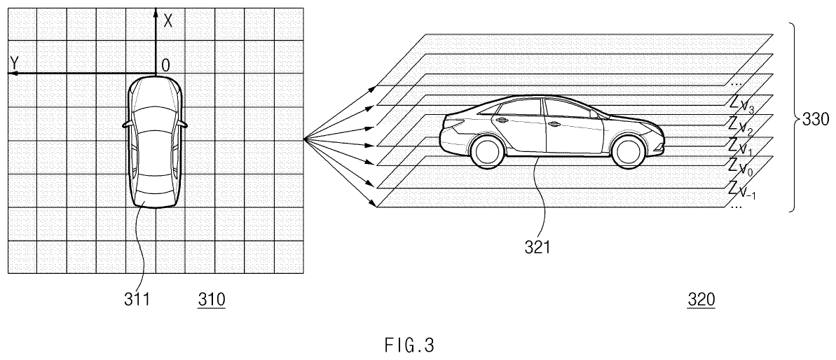

FIG. 3 shows an example of performing division into a plurality of planes with respect to a reference axis of a vehicle, according to an example of the present disclosure.

Referring to FIG. 3, in a first example 311, a processor (e.g., the processor 110 of FIG. 1) of a vehicle control device (e.g., the vehicle control device 100 of FIG. 1) according to an example, may identify or determine a vehicle coordinate system formed with respect to a vehicle 311.

For example, the processor may identify or determine a vehicle coordinate system with the center of the front bumper of the vehicle as an origin. For example, the vehicle coordinate system may include an x-axis extending toward the front of the vehicle and a y-axis extending toward the left side of the vehicle.

Referring to a second example 320, for example, the processor may generate a plurality of planes 330 to implement a vehicle coordinate system, expressed in two dimensions, in three dimensions. For example, the plurality of planes may be generated based on a z-axis that is different from the x-axis and y-axis described above. For example, the z-axis may be formed with respect to the origin described above.

For example, the processor may set the center point of the front bumper of a vehicle 321 as a reference axis (e.g., z-axis). The processor may generate the plurality of planes 330 with respect to the reference axis.

For example, the processor may render an image, which is acquired by the camera, in 3D based on generating the plurality of planes 330 with respect to the reference axis. For example, the processor may obtain image coordinates based on rendering the image in 3D. For example, the processor may obtain image coordinates based on encoding at least one of the intrinsic parameter of the camera, the extrinsic parameter of the camera, or the distortion coefficient of the camera, or any combination thereof. For example, the processor may obtain image coordinates including features capable of being input to the neural network model based on encoding at least one of the intrinsic parameter of the camera, the extrinsic parameter of the camera, or the distortion coefficient of the camera, or any combination thereof.

Among the plurality of planes 330, the face corresponding to the ground may be expressed as z_{V}_{₀}. Additionally, planes generated in a direction from the ground toward the sky or ceiling may be expressed as z_{V}_{ₙ} (n is a positive number), such as z_{V}_{₁}, z_{V}_{₂}, and/or z_{V}_{₃}.

If the plane corresponding to the ground among the plurality of planes 330 is expressed as z_{V}_{₀}, the planes generated in the direction from the ground toward the underground may be expressed as z_{V}_{_{−n}} (n is a positive number), such as z_{V}_{_{−1}}, z_{V}_{_{−2}}, and/or z_{V}_{_{−3}}.

In an example, the processor may convert the plurality of planes 330 into image coordinates of (u, v), respectively. The processor may convert the plurality of planes 330 into image coordinates respectively and store values in a two-dimensional array expressed as (H, W, 1). As described above, contents related to obtaining image coordinates based on the plurality of planes 330 may be referred to as camera parameter feature encoding. For example, if n planes are used, camera parameter features of size (H, W, N) may be generated.

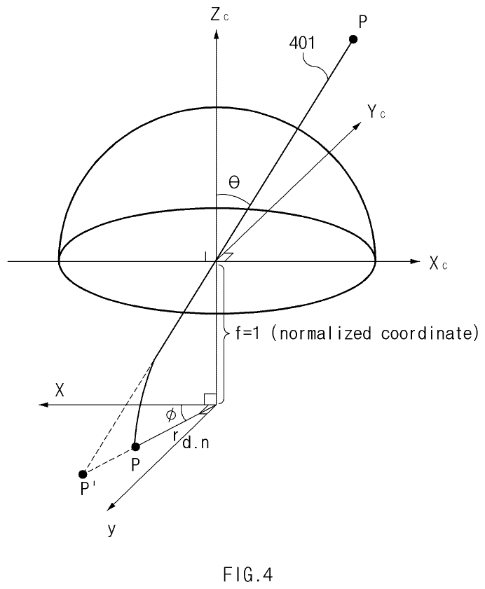

FIG. 4 shows an example related to camera distortion according to an example of the present disclosure.

Referring to FIG. 4, ‘P’ of a first line 401 may include an external object expressed in three dimensions. For example, p′ of the first line 401 may include the position of a pinhole camera. In FIG. 4, ‘p’ may mean that an external object is distorted by a lens included in the camera and projected to a position corresponding to ‘p’.

In an example, the processor (e.g., the processor 110 of FIG. 1) of a vehicle control device (e.g., the vehicle control device 100 of FIG. 1) may convert p′ with a length of r_{u.n.} into ‘p’ with a length of r_{d.n.}. For example, p′ and ‘p’ may be located on the same line.

A change in position due to lens distortion of an actual camera may mean a change from r_{u.n.} to r_{d.n.}, and the above change may mean that the position of a point projected from p′ to ‘p’ has changed.

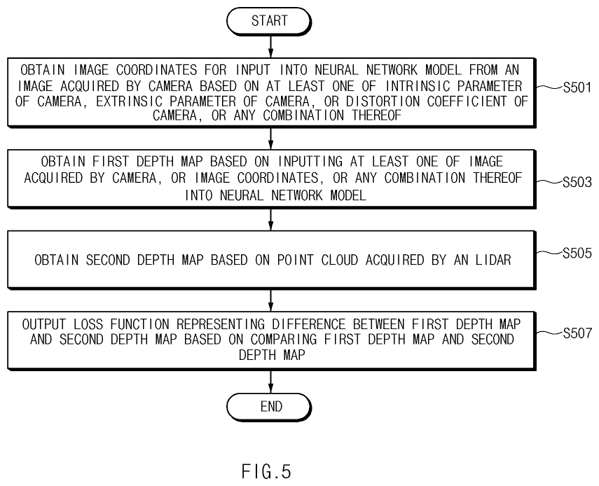

FIG. 5 shows an example of a flowchart related to a vehicle control method according to an example of the present disclosure.

Hereinafter, it is assumed that the vehicle control device 100 of FIG. 1 performs the process of FIG. 5. Additionally, in the description of FIG. 5, operations described as being performed by the device may be understood as being controlled by the processor 110 of the vehicle control device 100. One, some, or all steps of the process of FIG. 5, or portions thereof, may be performed by one or more other circuits. One or some, steps of the process of FIG. 5 may be omitted, performed in other orders, and/or otherwise modified, and/or one or more additional steps may be added.

At least one of operations in FIG. 5 may be performed by the vehicle control device 100 in FIG. 1. At least one of the operations in FIG. 5 may be controlled by the processor 110 in FIG. 1. The operations in FIG. 5 may be performed sequentially, but is not necessarily performed sequentially. For example, the order of the operations may be changed, and at least two operations may be performed in parallel.

Referring to FIG. 5, in operation S501, a vehicle control method according to an example may include obtaining image coordinates for input into a neural network model from an image acquired by a camera based on at least one of an intrinsic parameter of the camera, an extrinsic parameter of the camera, or a distortion coefficient of the camera, or any combination thereof.

For example, the vehicle control method may include identifying or determining the intrinsic parameter of the camera and the distortion coefficient of the camera based on feature modeling for the camera. The vehicle control method may include obtaining the extrinsic parameter of the camera based on a positional relationship between the camera and a vehicle including the camera.

For example, based on the fact that an angle between a first reference line facing the front of the vehicle including the camera and a second reference line formed around the optical axis of the camera exceeds a first reference angle, the vehicle control method may include performing automatic online calibration to realign the second reference line with respect to the first reference line.

For example, the vehicle control method may include adjusting at least one of the intrinsic parameter of the camera, or the extrinsic parameter of the camera, or any combination thereof, based on performing automatic online calibration.

For example, the vehicle control method may include obtaining a second vehicle coordinate system based on rotating a first vehicle coordinate system, formed with respect to the center point of the front bumper of the vehicle including the camera, by a second reference angle.

For example, the vehicle control method may include obtaining a third vehicle coordinate system corresponding to a camera coordinate system formed with respect to the camera, based on shifting the second vehicle coordinate system by a reference distance.

For example, the vehicle control method may include obtaining image coordinates based on the third vehicle coordinate system including the extrinsic parameter.

For example, the vehicle control method may include obtaining a first matrix based on applying a specified equation including a distortion coefficient, to the third vehicle coordinate system. For example, the specified equation may include Equation 7 below.

$$\frac{r ( θ , {k}_{1} , {k}_{2} , {k}_{3} , {k}_{4} , {k}_{5} )}{{r}_{u . n .}} \qquad [ Equation 7 ]$$

In Equation 7, k₁ to k₅ may denote the distortion coefficient of the camera. In Equation 7, θ may denote an angle at which light is incident on an image sensor included in the camera. In Equation 7, r_{u.n.} may be obtained based on coordinate values.

The vehicle control method according to an example may obtain image coordinates based on the first matrix.

According to an example, the vehicle control method may include obtaining a second matrix for input to the neural network model based on at least one of the focal length of the camera, the skew coefficient of the camera, or the principal point of the image, or any combination thereof. The second matrix may include Equation 8 below.

$$[ \begin{matrix}{f}_{x} & 0 & {c}_{x} \\ 0 & {f}_{y} & {c}_{y} \\ 0 & 0 & 1\end{matrix} ] \qquad [ Equation 8 ]$$

In Equation 8, fₓ and/or f_{y} may denote the focal length of the camera. In Equation 8, cₓ and/or c_{y} may denote the principal point of the image.

For example, the vehicle control method may include obtaining image coordinates based on a first matrix and a second matrix.

The vehicle control method according to an example may include obtaining image coordinates based on a plurality of planes divided with respect to the reference axis of a vehicle including the camera.

For example, the reference axis may include an axis perpendicular to the ground, with respect to a specified position of the vehicle.

In operation S503, the vehicle control method according to an example may include obtaining a first depth map based on inputting at least one of an image acquired by the camera, or image coordinates, or any combination thereof into a neural network model.

For example, the neural network model may include an encoder into which an image is input, and a decoder into which image coordinates are input. The neural network model may obtain image features for input to the decoder, based on an image input to an encoder. For example, the neural network model may input image features output from the encoder to the decoder, based on the image input to the encoder. The neural network model may output a first depth map based on the image features and the image coordinates.

Accordingly, the vehicle control method may include obtaining a first depth map based on inputting at least one of an image acquired by the camera, or image coordinates, or any combination thereof into a neural network model.

In operation S505, the vehicle control method according to an example may include obtaining a second depth map based on a point cloud acquired by an LIDAR.

In operation S507, the vehicle control method according to an example may include outputting a loss function representing a difference between the first depth map and the second depth map based on comparing the first depth map and the second depth map.

The vehicle control method according to an example may include training the neural network model by using the first depth map and the second depth map to reduce the size of the loss function.

The vehicle control method according to an example may include applying a first weight to an image obtained via a camera. The vehicle control method may include applying a second weight to image coordinates. The vehicle control method may include training a neural network model based on the image to which the first weight has been applied and the image coordinates to which the second weight has been applied.

As described above, the vehicle control method according to an example may include training the neural network model by using at least one of an image, or image coordinates, or any combination thereof to reduce the difference between the first depth map and the second depth map. The vehicle control method may provide the effect of identifying or determining an accurate distance between an external object and the vehicle in three dimensions using only a two-dimensional image, by reducing the difference between the first depth map and the second depth map.

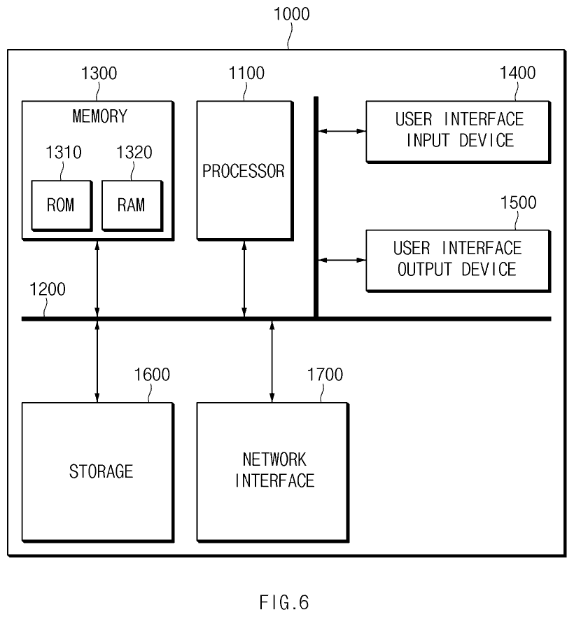

FIG. 6 shows an computing system related to a vehicle control device or a vehicle control method according to an example of the present disclosure.

Referring to FIG. 6, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the algorithm described in connection with the examples disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present disclosure has been made to solve the above-mentioned problems occurring in the prior art while advantages achieved by the prior art are maintained intact.

An example of the present disclosure provides a vehicle control device and a vehicle control method capable of improving the learning and/or inference of a neural network model (e.g., monocular depth estimation (MDE)) capable of operating on different types and/or positions of cameras.

An example of the present disclosure provides a vehicle control device and a vehicle control method capable of using the results of an automatic online calibration (AOC) algorithm to modify an extrinsic parameter of a camera mounted on a vehicle by recognizing a distortion of the camera.

An example of the present disclosure provides a vehicle control device and a vehicle control method capable of reducing an output error when performing inference using a neural network model on a camera view that does not exist in a learning database due to an error caused by a distortion of a camera mounted on a vehicle.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control device includes a camera, a LIDAR (light detection and ranging), a memory configured to store a neural network model and a processor, and the processor may obtain image coordinates for input to a neural network model from an image acquired by the camera based on at least one of an intrinsic parameter of the camera, an extrinsic parameter of the camera, or a distortion coefficient of the camera, or any combination thereof, obtain a first depth map based on inputting at least one of the image, or the image coordinates, or any combination thereof into the neural network model, obtain a second depth map based on a point cloud acquired by the LIDAR, and output a loss function representing a difference between the first depth map and the second depth map based on comparing the first depth map and the second depth map.

According to an example, the processor may identify or determine the intrinsic parameter and the distortion coefficient based on feature modeling for the camera, and identify or determine the extrinsic parameter based on a positional relationship between the camera and a vehicle including the camera.

According to an example, the processor may, based on an angle between a first reference line facing a front of a vehicle including the camera and a second reference line formed with respect to an optical axis of the camera exceeding a first reference angle, perform automatic online calibration to realign the second reference line with respect to the first reference line.

According to an example, the processor may obtain a second vehicle coordinate system based on rotating a first vehicle coordinate system, formed with respect to a center point of a front bumper of a vehicle including the camera, by a second reference angle, obtain a third vehicle coordinate system corresponding to a camera coordinate system formed with respect to the camera, based on shifting the second vehicle coordinate system by a reference distance, and obtain the image coordinates based on the third vehicle coordinate system including the extrinsic parameter.

According to an example, the processor may obtain a first matrix based on applying a specified equation including the distortion coefficient to the third vehicle coordinate system, and obtain the image coordinates based on the first matrix.

According to an example, the processor may obtain a second matrix for input to the neural network model based on at least one of a focal length of the camera, a skew coefficient of the camera, or a principal point of the image, or any combination thereof, obtain the image coordinates based on the first matrix and the second matrix, and obtain the first depth map based on inputting the image coordinates into the neural network model.

According to an example, the processor may obtain the image coordinates based on a plurality of planes separated with respect to a reference axis of a vehicle including the camera. The reference axis may include an axis perpendicular to a ground with respect to a specified position of the vehicle.

According to an example, the neural network model may include an encoder into which the image is input and a decoder into which the image coordinates are input, obtain image features for input to the decoder based on the image input to the encoder; and output the first depth map based on the image features and the image coordinates.

According to an example, the processor may train the neural network model based on the first depth map and the second depth map to reduce a size of the loss function.

According to an example, the processor may apply a first weight to the image, apply a second weight to the image coordinates, and train the neural network model based on the image to which the first weight has been applied and the image coordinates to which the second weight has been applied.

According to an example of the present disclosure, a vehicle control method includes obtaining image coordinates for input to a neural network model from an image acquired by a camera based on at least one of an intrinsic parameter of the camera, an extrinsic parameter of the camera, or a distortion coefficient of the camera, or any combination thereof, obtaining a first depth map based on inputting at least one of the image, or the image coordinates, or any combination thereof into the neural network model, obtaining a second depth map based on a point cloud acquired by the LIDAR, and outputting a loss function representing a difference between the first depth map and the second depth map based on comparing the first depth map and the second depth map.

According to an example, the vehicle control method may further include identifying or determining the intrinsic parameter and the distortion coefficient based on feature modeling for the camera, and identifying or determining the extrinsic parameter based on a positional relationship between the camera and a vehicle including the camera.

According to an example, the vehicle control method may further include, based on an angle between a first reference line facing a front of a vehicle including the camera and a second reference line formed with respect to an optical axis of the camera exceeding a first reference angle, performing automatic online calibration to realign the second reference line with respect to the first reference line.

According to an example, the vehicle control method may further include obtaining a second vehicle coordinate system based on rotating a first vehicle coordinate system, formed with respect to a center point of a front bumper of a vehicle including the camera, by a second reference angle, obtaining a third vehicle coordinate system corresponding to a camera coordinate system formed with respect to the camera, based on shifting the second vehicle coordinate system by a reference distance, and obtaining the image coordinates based on the third vehicle coordinate system including the extrinsic parameter.

According to an example, the vehicle control method may further include obtaining a first matrix based on applying a specified equation including the distortion coefficient to the third vehicle coordinate system, and obtaining the image coordinates based on the first matrix.

According to an example, the vehicle control method may further include obtaining a second matrix for input to the neural network model based on at least one of a focal length of the camera, a skew coefficient of the camera, or a principal point of the image, or any combination thereof, obtaining the image coordinates based on the first matrix and the second matrix, and obtaining the first depth map based on inputting the image coordinates into the neural network model.

According to an example, the vehicle control method may further include obtaining the image coordinates based on a plurality of planes separated with respect to a reference axis of a vehicle including the camera. The reference axis may include an axis perpendicular to a ground with respect to a specified position of the vehicle.

According to an example, the neural network model may include an encoder into which the image is input and a decoder into which the image coordinates are input, obtain image features for input to the decoder based on the image input to the encoder, and output the first depth map based on the image features and the image coordinates.

According to an example, the vehicle control method may further include training the neural network model based on the first depth map and the second depth map to reduce a size of the loss function.

According to an example, the vehicle control method may further include applying a first weight to the image, applying a second weight to the image coordinates, and training the neural network model based on the image to which the first weight has been applied and the image coordinates to which the second weight has been applied.

The above description is merely illustrative of the technical idea of the present disclosure, and various modifications and variations may be made without departing from the essential characteristics of the present disclosure by those skilled in the art to which the present disclosure pertains.

Accordingly, the example disclosed in the present disclosure is not intended to limit the technical idea of the present disclosure but to describe the present disclosure, and the scope of the technical idea of the present disclosure is not limited by the example. The scope of protection of the present disclosure should be interpreted by the following claims, and all technical ideas within the scope equivalent thereto should be construed as being included in the scope of the present disclosure.

The present technology may improve the learning and/or inference of a neural network model (e.g., monocular depth estimation (MDE)) capable of operating on the type and/or position of the camera.

Further, the present technology may recognize the distortion of the camera mounted on the vehicle and use the results of an automatic online calibration (AOC) algorithm to modify an extrinsic parameter of the camera.

Further, the present technology may reduce the output error when performing inference using a neural network model from a camera view that does not exist in the learning database due to errors caused by the distortion of the camera mounted on the vehicle.

In addition, various effects may be provided that are directly or indirectly understood through the disclosure.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling autonomous driving of a vehicle, the apparatus comprising:
a first sensor;
a second sensor;
a memory configured to store a neural network model; and
a processor configured to:
obtain coordinates of an object from an image comprising the object, wherein the image is acquired by the first sensor based on at least one of an intrinsic parameter of the first sensor, an extrinsic parameter of the first sensor, or a distortion coefficient of the first sensor;
obtain a first depth map by inputting at least one of the image or the coordinates into the neural network model;
obtain, based on a cluster of points acquired by the second sensor, a second depth map; and
determine, based on comparing the first depth map and the second depth map, a difference between the first depth map and the second depth map;
output a signal indicating the difference; and
control, based on the signal, autonomous driving of the vehicle.

2. The apparatus of claim 1, wherein the processor is configured to:
determine, based on feature modeling for the first sensor, the intrinsic parameter and the distortion coefficient; and
determine, based on a position of the first sensor on the vehicle, the extrinsic parameter.

3. The apparatus of claim 1, wherein the processor is configured to, based on an angle between a first reference line facing a front of the vehicle and a second reference line formed with respect to an optical axis of the first sensor exceeding a first reference angle, perform automatic online calibration to realign the second reference line with respect to the first reference line, wherein the vehicle comprises the first sensor.

4. The apparatus of claim 1, wherein the processor is configured to:
obtain a second vehicle coordinate system based on rotating a first vehicle coordinate system by a second reference angle, wherein the first vehicle coordinate system is formed with respect to a center point of a front bumper of the vehicle, and wherein the vehicle comprises the first sensor;
obtain, based on shifting the second vehicle coordinate system by a reference distance, a third vehicle coordinate system corresponding to a first sensor coordinate system, wherein the first sensor coordinate system is formed with respect to the first sensor; and
obtain the coordinates, wherein the third vehicle coordinate system comprises the extrinsic parameter.

5. The apparatus of claim 4, wherein the processor is configured to:
obtain a first matrix by applying a specified equation to the third vehicle coordinate system, wherein the specified equation comprises the distortion coefficient; and
obtain, based on the first matrix, the coordinates.

6. The apparatus of claim 5, wherein the processor is configured to:
obtain, based on at least one of a focal length of the first sensor, a skew coefficient of the first sensor, or a principal point of the image, a second matrix;
obtain, based on the first matrix and the second matrix, the coordinates; and
obtain the first depth map by inputting the coordinates into the neural network model.

7. The apparatus of claim 1, wherein the processor is configured to obtain, based on a plurality of planes separated with respect to a reference axis of the vehicle, the coordinates, wherein the vehicle comprises the first sensor; and
wherein the reference axis comprises an axis perpendicular to a ground with respect to a specified position of the vehicle.

8. The apparatus of claim 1, wherein the neural network model comprises an encoder into which the image is inputted and a decoder into which the coordinates are inputted, and wherein the neural network model is configured to:
obtain image features for input to the decoder by inputting the image to the encoder; and
output, based on the image features and the coordinates, the first depth map.

9. The apparatus of claim 1, wherein the processor is configured to train, based on the first depth map and the second depth map, the neural network model to reduce a size of the difference.

10. The apparatus of claim 1, wherein the processor is configured to:
apply a first weight to the image;
apply a second weight to the coordinates; and
train, based on the image and the coordinates, the neural network model, wherein the first weight has been applied to the image, and wherein the second weight has been applied to the coordinates.

11. A method performed by an apparatus, for controlling autonomous driving of a vehicle, the method comprising:
obtaining coordinates of an object from an image comprising the object, wherein the image is acquired by a first sensor based on at least one of an intrinsic parameter of the first sensor, an extrinsic parameter of the first sensor, or a distortion coefficient of the first sensor;
obtaining a first depth map by inputting at least one of the image or the coordinates into a neural network model;
obtaining, based on a cluster of points acquired by a second sensor, a second depth map; and
determining, based on comparing the first depth map and the second depth map, a difference between the first depth map and the second depth map;
outputting a signal indicating the difference; and
controlling, based on the signal, autonomous driving of the vehicle.

12. The method of claim 11, further comprising:
determining, based on feature modeling for the first sensor, the intrinsic parameter and the distortion coefficient; and
determining, based on a position of the first sensor on the vehicle, the extrinsic parameter.

13. The method of claim 11, further comprising:
based on an angle between a first reference line facing a front of the vehicle and a second reference line formed with respect to an optical axis of the first sensor exceeding a first reference angle, performing automatic online calibration to realign the second reference line with respect to the first reference line, wherein the vehicle comprises the first sensor.

14. The method of claim 11, further comprising:
obtaining a second vehicle coordinate system based on rotating a first vehicle coordinate system by a second reference angle, wherein the first vehicle coordinate system is formed with respect to a center point of a front bumper of the vehicle;
obtaining, based on shifting the second vehicle coordinate system by a reference distance, a third vehicle coordinate system corresponding to a first sensor coordinate system, wherein the first sensor coordinate system is formed with respect to the first sensor; and
obtaining the coordinates, wherein the third vehicle coordinate system comprises the extrinsic parameter.

15. The method of claim 14, further comprising:
obtaining a first matrix by applying a specified equation to the third vehicle coordinate system, wherein the specified equation comprises the distortion coefficient; and
obtaining, based on the first matrix, the coordinates.

16. The method of claim 15, further comprising:
obtaining, based on at least one of a focal length of the first sensor, a skew coefficient of the first sensor, or a principal point of the image, a second matrix;
obtaining, based on the first matrix and the second matrix, the coordinates; and
obtaining the first depth map by inputting the coordinates into the neural network model.

17. The method of claim 11, further comprising:
obtaining, based on a plurality of planes separated with respect to a reference axis of the vehicle, the coordinates, wherein the vehicle comprises the first sensor,
wherein the reference axis comprises an axis perpendicular to a ground with respect to a specified position of the vehicle.

18. The method of claim 11, wherein the neural network model comprises an encoder into which the image is inputted and a decoder into which the coordinates are inputted, wherein the neural network model is configured to:
obtain image features for input to the decoder by inputting the image to the encoder; and
output, based on the image features and the coordinates, the first depth map.

19. The method of claim 11, further comprising:
training, based on the first depth map and the second depth map, the neural network model to reduce a size of the difference.

20. The method of claim 11, further comprising:
applying a first weight to the image;
applying a second weight to the coordinates; and
training, based on the image and the coordinates, the neural network model, wherein the first weight has been applied to the image, and wherein the second weight has been applied to the coordinates.
